(19) United States
(12) Patent Application Publication
(10) Pub. No.: US 2023/0302758 A1
(43) Pub. Date: Sep. 28, 2023

(54) HANDLING OF CARDBOARD BLANKS

(71) Applicant: MULTIVAC SEPP HAGGENMUELLER SE & CO. KG, Wolfertschwenden (DE)

(72) Inventors: Robert MAIER, Babenhausen (DE); Dominik PATZ, Kempten (DE); Bernd HOEPNER, Kempten (DE); Philipp ADERMANN, Kempten (DE)

(73) Assignee: MULTIVAC SEPP HAGGENMUELLER SE & CO. KG, Wolfertschwenden (DE)

(21) Appl. No.: 18/120,473

(22) Filed: Mar. 13, 2023

(30) Foreign Application Priority Data
Mar. 23, 2022 (DE) 102022106782.3

(51) Int. Cl. B31B 50/78

(52) U.S. Cl. CPC B31B 50/78; B31B 2120/302

(57) ABSTRACT

A device for handling cardboard blanks comprises an erecting device with a plurality of engagement elements. The erecting device is configured to transition from a receiving configuration to a forming configuration. The erecting device is configured to move at least several of the engagement elements to transition from the receiving configuration to the forming configuration. In the receiving configuration, the erecting device is configured to receive a group of cardboard blanks each having a bottom region and side regions connected to the bottom region. The engagement elements are configured to erect the side regions of the cardboard blanks when the erecting device transitions from the receiving configuration to the forming configuration. The erecting device is configured to move the bottom regions of the cardboard blanks relative to each other when transitioning from the receiving configuration to the forming configuration.

### CROSS-REFERENCE TO RELATED APPLICATIONS

This application claims foreign priority benefits under 35 U.S.C. § 119(a)-(d) to German patent application number DE 10 2022 106 782.3, filed Mar. 23, 2022, which is incorporated by reference in its entirety.

### TECHNICAL FIELD

The present disclosure relates to the handling of cardboard blanks.

### BACKGROUND

It is known from practice to form a flat cardboard blank into a packaging tray by erecting side regions of the cardboard blank relative to a bottom region of the cardboard blank. Several packaging trays thus formed can be brought into a predetermined format and fed to further processing steps in the predetermined format.

### SUMMARY

It is an object of the disclosure to provide an improved way of handling cardboard blanks to be formed.

According to an aspect of the disclosure, a device for handling carton blanks is provided. The device includes an erecting device having a plurality of engagement elements. The erecting device is configured to transition from a receiving configuration to a forming configuration. The erecting device is configured to move at least several of the engagement elements to transition from the receiving configuration to the forming configuration. In the receiving configuration, the erecting device is configured to receive a group of cardboard blanks. The cardboard blanks each have a bottom region and side regions connected to the bottom region. The engagement elements are configured to erect the side regions of the cardboard blanks when the erecting device transitions from the receiving configuration to the forming configuration. The erecting device is configured to move the bottom regions of the cardboard blanks relative to each other when the erecting device transitions from the receiving configuration to the forming configuration.

The erecting device can be used to form several cardboard blanks by erecting the side regions of the cardboard blanks, in particular to form them simultaneously.

By moving the bottom regions of the cardboard blanks relative to each other, the cardboard blanks as a whole can be moved relative to each other. By moving the bottom regions of the cardboard blanks relative to each other, a distance between adjacent cardboard blanks can be changed. In particular, when the erecting device moves from the receiving configuration to the forming configuration, a format or grid in which the group of cardboard blanks is arranged can be changed. By moving the bottom regions of the cardboard blanks relative to each other, the group of cardboard blanks can be brought into a final format. The final format can be a format that facilitates further processing of the cardboard blanks.

The erection of the side regions of the cardboard blanks and the movement of the bottom regions of the cardboard blanks relative to each other can be done at least partially overlapping in time, in particular simultaneously.

The erecting the side regions of a cardboard blank can be done with respect to the bottom region of the cardboard blank. The erecting the side regions of a cardboard blank may include changing a three-dimensional structure of the cardboard blank. The erecting the side regions of a cardboard blank may include buckling or folding the cardboard blank. The erecting the side regions of a cardboard blank may comprise bending the side regions of the cardboard blank relative to the bottom region of the cardboard blank, in each case about an axis which runs along a boundary line between the bottom region and the respective side region. The axes may be parallel to the bottom region. The axes may be horizontal axes. The axes associated with the side regions of a cardboard blank may lie in a common plane.

Preferably, each cardboard blank comprises four side regions. Two side regions of each cardboard blank can be located on opposite sides of the bottom region of the cardboard blank.

The bottom regions of the cardboard blanks can be at least substantially rectangular in shape. A side region may be associated with each of the four sides of the rectangular bottom region.

By erecting the side regions of a cardboard blank, the cardboard blank can be formed into a packaging tray.

The erecting device may be configured to receive the cardboard blanks as flat cardboard blanks. In the case of the flat cardboard blanks, the bottom region and the side regions of a cardboard blank can extend in a common plane.

The erecting device is preferably configured to receive the group of cardboard blanks in a receiving format, wherein the cardboard blanks are arranged in a first grid in the receiving format. The erecting device may be configured to move the bottom regions of the cardboard blanks relative to each other when transitioning from the receiving configuration to the forming configuration such that the cardboard blanks are brought into a final format in which the cardboard blanks are arranged in a second grid relative to each other. The first grid and the second grid may differ from each other.

The engagement elements may be configured to erect the side regions of the cardboard blanks by engaging the side regions of the cardboard blanks when the erecting device transitions from the receiving configuration to the forming configuration.

The erecting device may include an engagement element drive arrangement. The engagement element drive arrangement may be configured to move at least several of the engagement elements to transition from the receiving configuration to the forming configuration. The engagement element drive arrangement may be configured to automatically move the engagement elements to transition from the receiving configuration to the forming configuration. The engagement element drive arrangement may be electrically operable.

The erecting device can be configured to receive the group of cardboard blanks in the receiving configuration such that the cardboard blanks lie in a common plane. The common plane can be a horizontal plane.

Engagement elements located on opposite sides of a cardboard blank can be configured to move relative to each other when the erecting device transitions from the receiving configuration to the forming configuration. During the relative movement, both opposing engagement elements may be moved or only one of the opposing engagement elements may be moved. The opposing engagement elements may each engage one of opposing side regions of the cardboard blank and erect the opposing side regions during the relative movement of the engagement elements towards each other.

The erecting device can be configured to receive the group of cardboard blanks such that four engagement elements are always arranged around one cardboard blank. Two of the four engagement elements can be opposite to each other in pairs. When the erecting device moves from the receiving configuration to the forming configuration, the engagement elements, which are opposite to each other in pairs, can each perform a relative movement directed towards each other.

At least one of the engagement elements can be engaged with two cardboard blanks simultaneously when the erecting device moves from the receiving configuration to the forming configuration. When the erecting device transitions from the receiving configuration to the forming configuration, the engagement element can, in particular, simultaneously engage with one side region of each of two different cardboard blanks. The engagement element can promote erection of both side regions with which the engagement element is engaged.

The erecting device can be configured to move the engagement elements at different speeds when transitioning from the receiving configuration to the forming configuration. For example, different groups of engagement elements can each be moved at a speed associated with the group, wherein the speeds associated with the groups can differ from one another.

The speeds at which the engagement elements are moved can be coordinated with one another and with the movement of the bottom regions of the cardboard blanks such that, when transitioning from the receiving configuration to the forming configuration, each engagement element performs a relative movement towards each side region engaged with the engagement element, in particular at a relative speed which is the same for all pairs of engagement element and side region engaged with the engagement element.

When the erecting device transitions from the receiving configuration to the forming configuration, one or more engagement elements can remain stationary. The engagement elements that remain stationary can nevertheless each perform a relative movement with respect to side regions with which they are engaged, in particular due to a movement of the bottom regions of the cardboard blanks.

The engagement elements can be arranged in a grid. The grid can be a rectangular grid, for example. The erecting device can be configured to move engagement elements located further externally in the grid at a greater speed than engagement elements located further internally in the grid when transitioning from the receiving configuration to the forming configuration. When transitioning from the receiving configuration to the forming configuration, all engagement element movements can be directed towards an interior of the grid.

When transitioning from the receiving configuration to the forming configuration, each engagement element can remain engaged with at least a side region of a cardboard blank.

The movement of the at least several of the engagement elements when the erecting device transitions from the receiving configuration to the forming configuration may include a movement in a common plane. The common plane may be a horizontal plane. The common plane may be a plane that is parallel to a plane in which the bottom regions of the cardboard blanks are located.

The movement of the at least plurality of engagement elements when the erecting device transitions from the receiving configuration to the forming configuration may include lifting the at least plurality of engagement elements. In particular, the lifting of the engagement elements may be performed in engagement with at least one side region of a cardboard blank, respectively, to promote erection of the side region.

The engagement elements can each have at least one engagement surface for engaging with a cardboard blank. The engagement surfaces can be configured as guide surfaces for erection of the side regions of the cardboard blanks. The engagement surfaces can be curved or inclined surfaces. The engagement surfaces can have an incline relative to a direction of movement of the engagement elements. The engagement surfaces may be inclined with respect to a horizontal plane or have an incline with respect to a horizontal plane. The engagement surfaces can be configured as concave surfaces.

The erecting device may include holding elements. The holding elements may be configured to hold the bottom regions of the cardboard blanks. The erecting device may be configured to move at least a plurality of the holding elements to transition from the receiving configuration to the forming configuration. The movement of the holding elements can cause or promote the relative movement of the bottom regions of the cardboard blanks. One retaining element each can be assigned to a cardboard blank and hold its bottom region. The holding elements may be configured to hold the bottom regions by means of negative pressure. The holding elements can each have a suction device for holding a bottom region of a cardboard blank.

The erecting device may include a holding element drive arrangement. The holding element drive arrangement may be configured to move at least a plurality of the holding elements to transition from the receiving configuration to the forming configuration.

The erecting device, in particular the holding element drive arrangement, can be configured to move adjacent holding elements relative to one another when the erecting device moves from the receiving configuration to the forming configuration. Thus, a distance between the bottom regions of adjacent cardboard blanks can be reduced.

The erecting device, in particular the holding element drive arrangement, can be configured to move the holding elements at different speeds when changing from the receiving configuration to the forming configuration. For example, different groups of holding elements may each be moved at a speed associated with the group, wherein the speeds associated with the groups may differ from one another.

The speeds at which the holding elements are moved can be coordinated with one another such that, when transitioning from the receiving configuration to the forming configuration, each holding element performs a relative movement towards each adjacent holding element, in particular at a relative speed that is the same for all pairs of adjacent holding elements.

When the erecting device transitions from the receiving configuration to the forming configuration, one or more holding elements can remain stationary. The holding elements that remain stationary can nevertheless each perform a relative movement with respect to adjacent holding elements, in particular due to a movement of the adjacent holding elements.

The holding elements can be arranged in a grid. The grid can be a rectangular grid, for example. The erecting device may be configured to move holding elements located at positions further outward in the grid at a greater speed than holding elements located at positions further inward in the grid when transitioning from the receiving configuration to the forming configuration. When transitioning from the receiving configuration to the forming configuration, all movements of holding elements can be directed towards a center of the grid.

According to another aspect of the disclosure, a method for handling cardboard blanks is provided. A group of cardboard blanks is provided. The cardboard blanks each have a bottom region and side regions connected to the bottom region. The side regions of the cardboard blanks are erected. When erecting the side regions, the bottom regions of the cardboard blanks are moved relative to each other.

Preferably, the side regions of the cardboard blanks can be erected by engagement with engagement elements. At least several of the engagement elements can be moved to erect the cardboard blanks.

The bottom regions of the cardboard blanks can each be held by a holding element when erecting the side regions. At least several of the holding elements can be moved when erecting the cardboard blanks.

As described, the disclosure relates to a device for handling cardboard blanks and to a method for handling cardboard blanks. The device may be suitable, adapted and/or configured for carrying out the method. The method may be carried out using the device. Features and explanations described with respect to the device may be transferred to the method. Features or explanations described with respect to the method may be transferred to the device.

### BRIEF DESCRIPTION OF THE DRAWINGS

In the following, the disclosure is further explained by means of embodiments with reference to the Figures.

FIG. 1 shows a schematic top view of a device for handling cardboard blanks according to an embodiment, wherein the erecting device is provided in the receiving configuration;

FIG. 2 shows a schematic sectional view of the device in the state shown in FIG. 1 along the section line I-I indicated in FIG. 1;

FIG. 3 shows a schematic top view of the device according to the embodiment with inserted cardboard blanks;

FIG. 4 shows a schematic sectional view of the device in the state shown in FIG. 3 along the section line II-II indicated in FIG. 3;

FIG. 5 shows a schematic top view of the device according to the embodiment after the erecting device has transitioned to the forming configuration;

FIG. 6 shows a schematic sectional view of the device in the state shown in FIG. 5 along the section line III-III indicated in FIG. 5;

FIG. 7 shows a schematic sectional view of a device according to an alternative embodiment, wherein the erecting device is in the receiving configuration; and

FIG. 8 shows a schematic sectional view of the device according to the alternative embodiment, wherein the erecting device is in the forming configuration.

### DETAILED DESCRIPTION

FIG. 1 shows a schematic top view of a device 1 for handling cardboard blanks 3. The device 1 comprises an erecting station or erecting device 5 with receiving stations 7 for cardboard blanks 3. In the illustrated embodiment, six receiving stations 7 for cardboard blanks 3 are provided. A different number of receiving stations 7 for cardboard blanks 3 would also be conceivable. The receiving stations 7 for cardboard blanks 3 are arranged in a rectangular grid, which in the illustrated embodiment is a 2×3 grid.

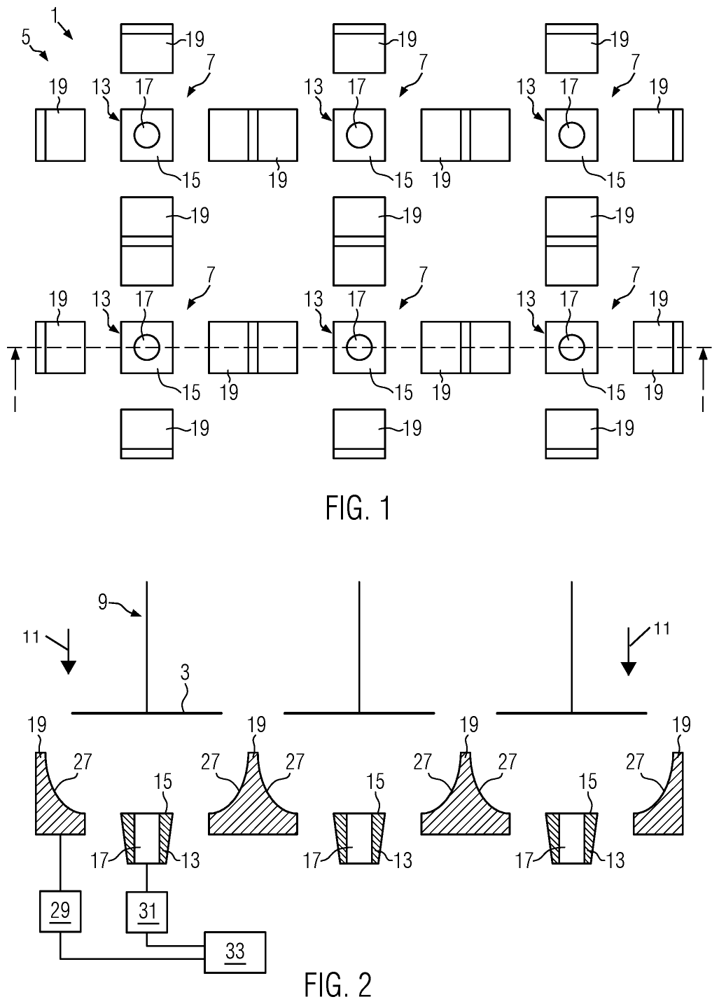

FIG. 2 shows a sectional view through the device 1, wherein the section is indicated by the line I-I in FIG. 1. FIG. 2 shows insertion devices 9 of the device 1. For the sake of clarity, the insertion devices 9 are not shown in FIG. 1. The insertion devices 9 are configured to insert a cardboard blank 3 from above into each receiving station 7 of the erecting device 5. This is shown by the arrows 11 in FIG. 2. The insertion devices 9 can, for example, each be configured to receive a cardboard blank 3 from a supply and deposit it in a receiving station 7. For this purpose, the insertion devices 9 can each have a holding device for a cardboard blank 3, for example a suction device or a gripper. Alternatively, it would be conceivable to provide stacking devices above the receiving stations 7 in order to stack the cardboard blanks 3 directly in the receiving stations 7.

Each receiving station 7 of the erecting device 5 comprises a holding element 13. The holding elements 13 each define a supporting surface 15 on which a cardboard blank 3 inserted into the respective receiving station 7 rests flat at least in certain regions. At least one suction opening 17 is provided in the supporting surface 15 in each case, through which negative pressure can be applied to the cardboard blank 3 in order to hold the cardboard blank 3 on the holding element 13.

Each receiving station 7 of the erecting device 5 is surrounded by four engagement elements 19, wherein two adjacent receiving stations 7 are assigned to certain engagement elements 19.

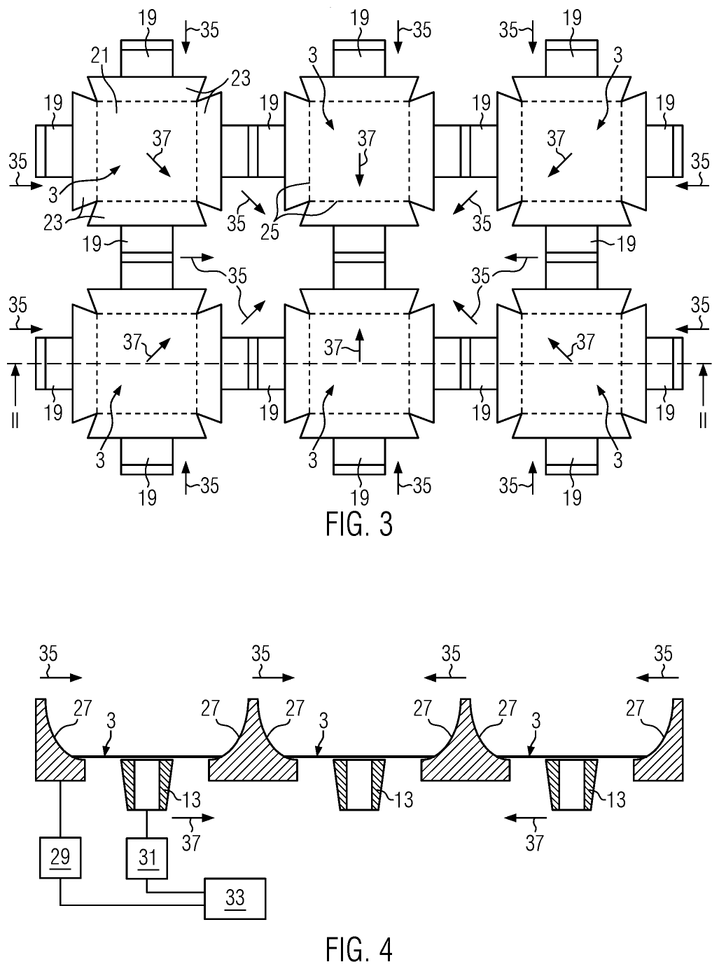

FIGS. 3 and 4 show the situation after the cardboard blanks 3 have been placed in the receiving stations 7. As can be seen from FIG. 3, each cardboard blank 3 comprises a bottom region 21 and four side regions 23 connected to the bottom region 21. In the situation shown in FIGS. 3 and 4, the cardboard blanks 3 are in the form of flat cardboard blanks 3. As shown in FIG. 3, boundary lines 25 between the bottom region 21 and the side regions 23 of a cardboard blank 3 can optionally be pre-processed, for example by providing a predetermined knuckle line. The bottom regions 21 of the cardboard blanks 3 rest on the receiving surfaces 15 of the holding elements 13 and are sucked towards the suction openings 17 and thus held on the holding elements 13.

As shown in FIG. 4, the engagement elements 19 each comprise at least one engagement surface 27. The side regions 23 of the cardboard blanks 3 are each in contact with an engagement surface 27 of the associated engagement element 19. Engagement elements 19 which are assigned to two side regions 23 comprise two opposite engagement surfaces 27.

In FIGS. 1 to 4, the erecting device 5 is provided in a receiving configuration. After the cardboard blanks 3 have been inserted in the receiving configuration, the erecting device 5 is brought into a forming configuration. To move the erecting device 5 from the receiving configuration to the forming configuration, the engagement elements 19 are moved relative to each other. In addition, the holding elements 13 are moved relative to each other. FIG. 4 schematically shows an engagement element drive arrangement 29 (e.g., one or more electric or pneumatic actuators) for moving the engagement elements 19 and a holding element drive arrangement 31 (e.g., one or more electric or pneumatic actuators) for moving the holding elements 13. The engagement element drive arrangement 29 and the holding element drive arrangement 31 can be controlled by a control device 33.

Directions of movement of the engagement elements 19 are illustrated by the arrows 35 in FIGS. 3 and 4. Two engagement elements 19 opposite one another with respect to a cardboard blank 3 are always moved towards one another relative to one another in order to transfer the erecting device 5 to the forming configuration. However, this does not necessarily mean that all engagement elements 19 actually perform a movement. In the illustrated example, the engagement elements 19 provided between the two rows of three cardboard blanks 3 remain stationary, while all other engagement elements 19 are moved.

As shown in FIG. 4, the engagement surfaces 27 of the engagement elements 19 are formed such that, when engagement elements 19 that are opposite each other with respect to a cardboard blank 3 are moved towards each other, they promote erection of opposite side regions 23 of the cardboard blank 3. The side regions 23 of the cardboard blanks 3 are thus erected to form the cardboard blanks 3 into packaging trays.

When the erecting device 5 is brought into the forming configuration, the holding elements 13 are moved such that adjacent holding elements 13 perform a relative movement towards each other. In FIGS. 3 and 4, the directions of movement of the holding elements 13 are shown by arrows 37. In the illustrated embodiment, all holding elements 13 actually perform a movement in space. However, this is not absolutely necessary. For example, at least one holding element 13 could be stationary in space, but there could still be a relative movement to adjacent holding elements 13, namely due to a movement of the adjacent holding elements 13.

The movement of the holding elements 13 causes the bottom regions 21 of the cardboard blanks 3, and thus the cardboard blanks 3 as a whole, which are held by the suction effect on the holding elements 13, to move towards each other. The movement of the engagement elements 19 and the movement of the holding elements 13 occur at least partially overlapping in time. The movement of the engagement elements 19 and the movement of the holding elements 13 are coordinated with one another such that the side regions 23 of the cardboard blanks 3 remain in contact with the engagement surfaces 27 of the engagement elements 19 when the erecting device 5 transitions into the forming configuration and are erected by engagement therewith.

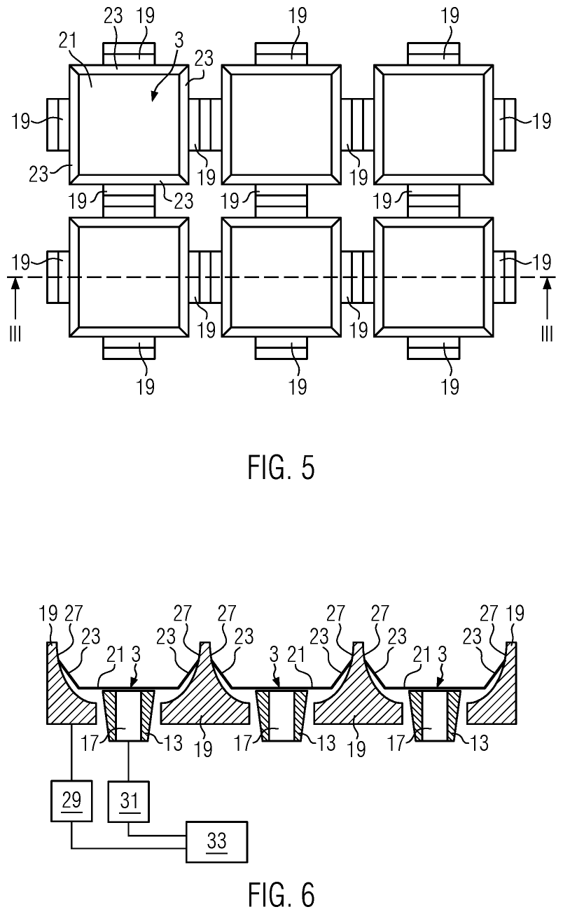

FIGS. 5 and 6 show the situation after the erecting device 5 has transitioned to the forming configuration. The side regions 23 of the cardboard blanks 3 have been erected so that the cardboard blanks 3 have been formed into packaging trays. In FIGS. 1 to 4, the erecting device 5 is in the receiving configuration. In FIGS. 5 and 6, the erecting device 5 is in the forming configuration. In the forming configuration, the cardboard blanks 3 received in the receiving stations 7 are in a narrower format than in the receiving configuration. In the forming configuration, a distance between the bottom regions 21 of adjacent cardboard blanks 3 is smaller than in the receiving configuration. After the erecting device 5 has transitioned to the forming configuration, the formed cardboard blanks 3 can be removed from the receiving stations 7 and fed to further processing steps, for example by means of a gripper device. Alternatively, the formed cardboard blanks 3 received in the receiving stations 7 could be transported further by a movement of the erecting device 5 as a whole and fed to a next processing step.

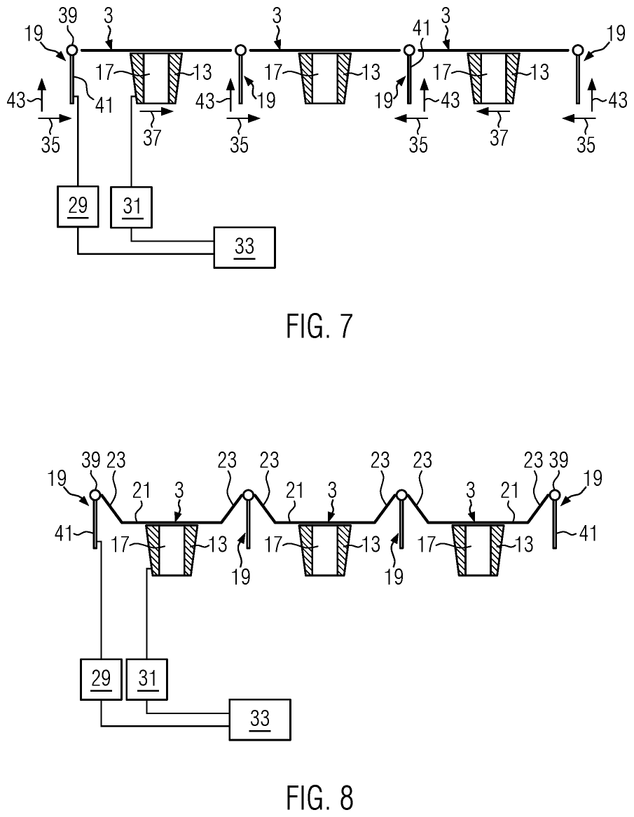

FIGS. 7 and 8 show an alternative configuration of the engagement elements 19. In FIG. 7, the erecting device 5 is in the receiving configuration, wherein the cardboard blanks 3 are already received in the receiving stations 7. The state shown in FIG. 7 corresponds to the state shown in FIG. 4. In FIG. 8, the erecting device 5 is in the forming configuration. The state shown in FIG. 8 corresponds to the state shown in FIG. 6.

In the embodiment shown in FIGS. 7 and 8, each holding element 19 includes a handle portion 41 and an engagement portion 39 attached thereto. The engagement surface 27 of an engagement element 19 is formed by a surface of the engagement portion 39 of the engagement element 19. In the illustrated embodiment, the engagement portion 39 is spherical. Other shapes of the engagement portions 39 would also be possible, for example, an ellipsoidal form or a trapezoidal form. The engagement portions 39 are each attached to an upper end of the handle portion 41.

As shown by the arrows 35 in FIG. 7, the engagement elements 19 are moved relative to each other in a horizontal plane when the erecting device 5 transitions from the receiving configuration to the forming configuration. This movement corresponds to the movement of the engagement elements 19 of the embodiment shown in FIGS. 1 to 6. The movement symbolized by arrows 35 is superimposed on a horizontal upward movement of the engagement elements 19 symbolized by arrows 43 in FIG. 7. Lifting the engagement elements 19 promotes erection of the side regions 23 of the cardboard blanks 3. Otherwise, the functionality of the embodiment of FIGS. 7 and 8 may correspond to the functionality of the embodiment of FIGS. 1 to 6, in particular with respect to the movement of the holding elements 13.

As those skilled in the art will understand, the engagement element drive arrangement 29, the holding element drive arrangement 31, the control device 33, as well as any other controller, unit, component, system, subsystem, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC) or Electronic Control Unit (ECU), or several processors and various circuitry and/or hardware may be distributed among several separate components, whether individually packaged or assembled into a System-on-a-Chip (SoC).

What is claimed is:

1. A device for handling cardboard blanks, comprising:
an erecting device with a plurality of engagement elements;
wherein the erecting device is configured to transition from a receiving configuration to a forming configuration;
wherein the erecting device is configured to move at least several of the engagement elements to transition from the receiving configuration to the forming configuration;
wherein the erecting device in the receiving configuration is configured to receive a group of cardboard blanks each having a bottom region and side regions connected to the bottom region;
wherein the engagement elements are configured to erect the side regions of the cardboard blanks when the erecting device transitions from the receiving configuration to the forming configuration; and
wherein the erecting device is configured to move the bottom regions of the cardboard blanks relative to each other upon transitioning from the receiving configuration to the forming configuration.

2. The device according to claim 1, wherein the erecting device is configured to receive the group of cardboard blanks in the receiving configuration such that the cardboard blanks lie in a common plane.

3. The device according to claim 1, wherein engagement elements of the plurality of engagement elements lying on opposite sides of a cardboard blank are configured to perform a relative movement directed towards each other when the erecting device transitions from the receiving configuration to the forming configuration.

4. The device according to claim 1, wherein the erecting device is configured to receive the group of cardboard blanks such that four engagement elements of the plurality of engagement elements are arranged around each cardboard blank, wherein two of the four engagement elements are opposite to each other in pairs.

5. The device according to claim 1, wherein at least one of the plurality of engagement elements is simultaneously engageable with two cardboard blanks when the erecting device transitions from the receiving configuration to the forming configuration.

6. The device according to claim 1, wherein the erecting device is configured to move the at least several of the engagement elements at different speeds when transitioning from the receiving configuration to the forming configuration.

7. The device according to claim 1, wherein the plurality of engagement elements are arranged in a grid, and wherein the erecting device is configured to move engagement elements of the plurality of engagement elements located at positions further outward in the grid at a greater speed than engagement elements of the plurality of engagement elements located at positions further inward in the grid when transitioning from the receiving configuration to the forming configuration.

8. The device according to claim 1, wherein the movement of the at least several of the engagement elements when the erecting device transitions from the receiving configuration to the forming configuration comprises a movement in a common plane.

9. The device according to claim 1, wherein the movement of the at least several of the engagement elements when the erecting device transitions from the receiving configuration to the forming configuration comprises lifting the at least several of the engagement elements.

10. The device according to claim 1, wherein the engagement elements each have at least one engagement surface for engagement with a cardboard blank, wherein the engagement surfaces are configured as guide surfaces for erecting the side regions of the cardboard blanks.

11. The device according to claim 1, wherein the erecting device comprises holding elements configured to hold the bottom regions of the cardboard blanks.

12. The device according to claim 11, wherein the erecting device is configured to move at least several of the holding elements to transition from the receiving configuration to the forming configuration.

13. A method for handling cardboard blanks, comprising:
providing a group of cardboard blanks, wherein the cardboard blanks each have a bottom region and side regions connected to the bottom region; and
erecting the side regions of the cardboard blanks;
wherein the bottom regions of the cardboard blanks are moved relative to each other when erecting the side regions.

14. The method according to claim 13, wherein the side regions of the cardboard blanks are erected by engagement with engagement surfaces of engagement elements, wherein at least several of the engagement elements are moved to erect the cardboard blanks.

15. The method according to claim 13, wherein the bottom regions of the cardboard blanks are each held by a holding element when erecting the side regions, wherein at least several of the holding elements are moved when the cardboard blanks are being erected.

16. A method for handling cardboard blanks by an erecting device, the method comprising:
receiving a group of cardboard blanks in receiving stations of the erecting device, wherein the cardboard blanks each have a bottom region and side regions connected to the bottom region; and
erecting the side regions of the cardboard blanks by the erecting device;
wherein the bottom regions of the cardboard blanks are moved relative to each other during the erecting of the side regions.

17. The method according to claim 16, wherein the side regions of the cardboard blanks are erected by engagement with engagement surfaces of engagement elements of the erecting device, wherein at least several of the engagement elements are moved to erect the side regions.

18. The method according to claim 17, wherein the bottom regions of the cardboard blanks are each held by a holding element of the erecting device when erecting the side regions, wherein at least several of the holding elements are moved when the side regions are being erected.
